(19) United States
(12) Patent Application Publication
(10) Pub. No.: US 2022/0035518 A1
(43) Pub. Date: Feb. 3, 2022

(54) Display apparatus having on-screen display control mechanism and on-screen display control method of the same

(71) Applicant: REALTEK SEMICONDUCTOR CORPORATION, Hsinchu (TW)

(72) Inventor: CHUN-HAO HUANG, HSINCHU (TW)

(21) Appl. No.: 17/384,981

(22) Filed: Jul. 26, 2021

(30) Foreign Application Priority Data
Jul. 28, 2020 (TW) 109125422

(51) Int. Cl. G06F 3/0484; G09G 5/00; G06F 3/0354; G06F 3/0482

(52) U.S. Cl. CPC G06F 3/04847; G09G 5/003; G09G 2354/00; G06F 3/0482; G09G 2320/0606; G06F 3/03543

(57) ABSTRACT

The present invention discloses a display apparatus having on-screen display control mechanism. A signal receiving terminal receives a mouse input signal. A switch circuit transmits the mouse input signal to a first output terminal and a second output terminal respectively under a mouse signal transmission mode and an on-screen display control mode. A display control circuit is configured to perform the steps outlined below. A display panel is controlled to display an on-screen display frame. Location information and key information are retrieved from the mouse input signal. A mouse cursor is displayed over the on-screen display frame according to the location information. A control item corresponding to the mouse cursor is selected as a selected control item according to the location information and the key information. A control function corresponding to the selected control item is executed.

### BACKGROUND OF THE INVENTION

### 1. Field of the Invention

The present invention relates to a display apparatus having on-screen display control mechanism and an on-screen display control method of the same.

### 2. Description of Related Art

A display apparatus not only can display a display frame based on display data, but also can display an on-screen display frame that allows a user to adjust display parameters of the display apparatus, e.g. the brightness, the contrast and the size of the frame.

A common method to operate the on-screen display frame is to dispose physical keys on the display apparatus. However, the operation of the physical keys is not intuitive, in which the parameter-adjusting flow needs to be performed from the very beginning once an operation mistake is made. Further, in some display apparatus, the physical keys are disposed at the rear end of the display apparatus such that the user is not easy to touch the right key. Such a disposition method does not allow the user to fluently adjust the display parameters of the display apparatus.

### SUMMARY OF THE INVENTION

In consideration of the problem of the prior art, an object of the present invention is to supply a display apparatus having on-screen display control mechanism and an on-screen display control method of the same.

The present invention discloses a display apparatus having on-screen display control mechanism that includes a signal receiving terminal, a switch circuit, a display panel and a display control circuit. The signal receiving terminal is configured to receive a mouse input signal. The switch circuit is configured to receive the mouse input signal from the signal receiving terminal through an input terminal, and to transmit the mouse input signal to a first output terminal under a mouse signal transmission mode and transmit the mouse input signal to a second output terminal under an on-screen display control mode. The display control circuit is electrically coupled to the switch circuit and the display panel and configured for performing the following steps. The display panel is controlled to display an on-screen display frame having a plurality of control items, and the mouse input signal is received from the second output terminal under the on-screen display control mode. Location information and key information are retrieved from the mouse input signal. The display panel is controlled to display a mouse cursor over the on-screen display frame according to the location information. One of the control items corresponding to the mouse cursor is selected as a selected control item according to the location information and the key information. A control function corresponding to the selected control item is executed.

The present invention also discloses an on-screen display control method used in a display apparatus that includes the steps outlined below. A mouse input signal is received by a signal receiving terminal. The mouse input signal is received from the signal receiving terminal through an input terminal by a switch circuit, the mouse input signal is transmitted to a first output terminal under a mouse signal transmission mode and the mouse input signal is transmitted to a second output terminal under an on-screen display control mode by the switch circuit. The display panel is controlled to display an on-screen display frame having a plurality of control items, and the mouse input signal is received from the second output terminal under the on-screen display control mode by a display control circuit. Location information and key information are retrieved from the mouse input signal by the display control circuit. The display panel is controlled to display a mouse cursor over the on-screen display frame according to the location information by the display control circuit. One of the control items corresponding to the mouse cursor is selected as a selected control item according to the location information and the key information by the display control circuit. A control function corresponding to the selected control item is executed by the display control circuit.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 illustrates a circuit diagram of a display apparatus having an on-screen display control mechanism according to an embodiment of the present invention.

FIG. 2 illustrates a diagram of an on-screen display frame displayed by the display panel according to an embodiment of the present invention.

FIG. 3 illustrates a flow chart of an on-screen display control method according to an embodiment of the present invention.

### DETAILED DESCRIPTION OF THE PREFERRED EMBODIMENTS

An aspect of the present invention is to provide a display apparatus having on-screen display control mechanism and an on-screen display control method of the same to be able to transmit a mouse input signal to a computer host terminal and make use of the mouse input signal to adjust an on-screen display frame in an intuitive way by disposing a switch circuit.

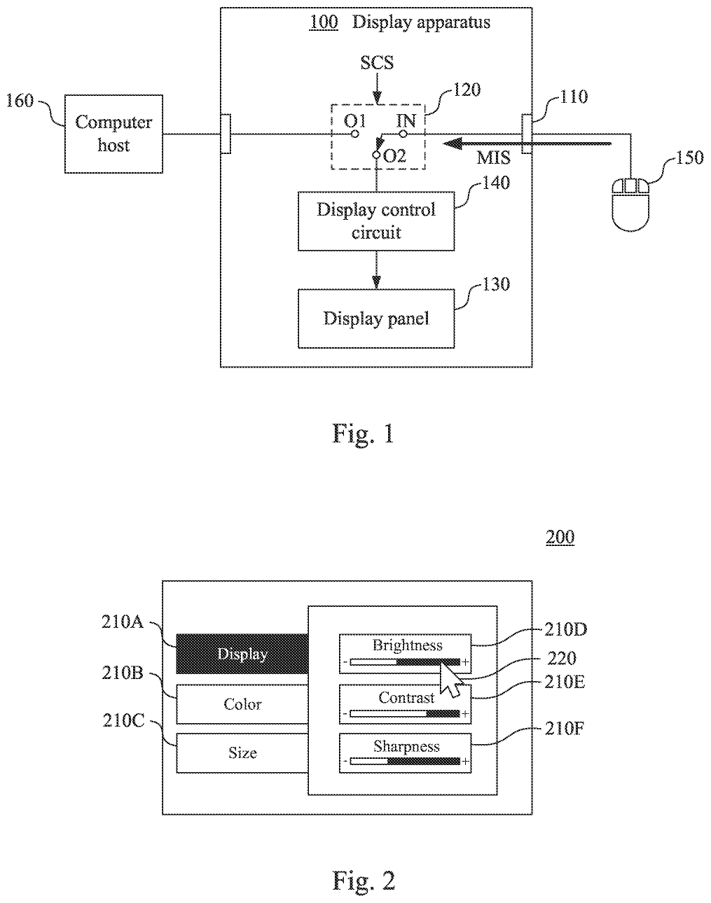

Reference is now made to FIG. 1. FIG. 1 illustrates a circuit diagram of a display apparatus 100 having an on-screen display control mechanism according to an embodiment of the present invention. The display apparatus 100 includes a signal receiving terminal 110, a switch circuit 120, a display panel 130 and a display control circuit 140.

The signal receiving terminal 110 is configured to receive a mouse input signal MIS. In an embodiment, the signal receiving terminal 110 can be such as, but not limited to a universal serial bus (USB) connection interface to be electrically coupled to a mouse 150 external to the display apparatus 100 and to receive the mouse input signal MIS from the mouse 150.

The switch circuit 120 includes an input terminal IN, a first output terminal O1 and a second output terminal O2. The switch circuit 120 is configured to receive the mouse input signal MIS from the signal receiving terminal 110 through the input terminal IN. Further, based on different operation modes, the switch circuit 120 selectively transmits the mouse input signal MIS to one of the first output terminal O1 and the second output terminal O2.

In an embodiment, the switch circuit 120 can be switched to operate between a mouse signal transmission mode and an on-screen display control mode according to a switch control signal SCS. In an embodiment, the switch control signal SCS can be selectively generated from the computer host terminal 160 electrically coupled to the display apparatus 100 or generated from a physical key (not illustrated) included in the display apparatus 100 so as to switch the switch circuit 120 to operate between the mouse signal transmission mode and the on-screen display control mode.

Under the mouse signal transmission mode, the switch circuit 120 transmits the mouse input signal MIS to the first output terminal O1. In an embodiment, the first output terminal O1 is electrically coupled to the computer host terminal 160 electrically coupled to the display apparatus 100. In an embodiment, the electrical coupling between the computer host terminal 160 and the first output terminal O1 of the display apparatus 100 is a path of such as, but not limited to Type-C USB format to accomplish a two-way signal transmission mechanism.

As a result, the computer host terminal 160 can transmit display data (not illustrated) to the display apparatus 100 through the path between the first output terminal O1 and the computer host terminal 160 described above. Further, the display data can be transmitted through a path (not illustrated) between the first output terminal O1 and the display control circuit 140 inside of the display apparatus 100 to the display control circuit 140. The display control circuit 140 processes the display data and further displays the display data on the display panel 130.

At the same time, by disposing the switch circuit 120, the display apparatus 100 can transmit the mouse input signal MIS through the path between the first output terminal O1 and the computer host terminal 160 described above to the computer host terminal 160 to control the computer host terminal 160.

On the other hand, under the on-screen display control mode, the switch circuit 120 transmits the mouse input signal MIS to the second output terminal O2. In an embodiment, the second output terminal O2 is electrically coupled to the display control circuit 140.

The display control circuit 140 is electrically coupled to the switch circuit 120 and the display panel 130. The display control circuit 140 is configured to control the display panel 130 to display an on-screen display frame having a plurality of control items and receive the mouse input signal MIS from the second output terminal O2 under the on-screen display control mode.

Reference is now made to FIG. 2. FIG. 2 illustrates a diagram of an on-screen display frame 200 displayed by the display panel 130 according to an embodiment of the present invention.

As illustrated in FIG. 2, the on-screen display frame 200 includes a plurality of control items 210A˜210F. The control items 210A˜210C can be such as, but not limited to the menu items for adjusting display parameters, color parameters and size parameters. The control items 210D˜210F correspond to the control item 210A and include the display parameter control items for adjusting brightness, contrast and sharpness.

The display control circuit 140 is configured to retrieve location information and key information (not illustrated) of the mouse 150 from the mouse input signal MIS. In an embodiment, the mouse input signal MIS includes human interface device (HID) descriptor information. The display control circuit 140 is configured to retrieve the location information and the key information from the human interface device descriptor information.

The location information includes an X-axis position and a Y-axis position of the mouse 150 relative to the on-screen display frame 200. The key information corresponds to the physical key on the mouse 150 that is triggered.

As a result, the display control circuit 140 controls the display panel 130 to display a mouse cursor 220 over the on-screen display frame 200 according to the location information. On the other hand, the display control circuit 140 selects one of the control items corresponding to the mouse cursor 220, e.g. the control item 210B or the control item 210C, as a selected control item according to the location information and the key information. The display control circuit 140 further executes the control function that the selected control item corresponds to.

For example, when the location information indicates that the location of the mouse cursor 220 corresponds to the control item 210B and the key information indicates that the key on the mouse 150 is triggered, the control function that the display control circuit 140 executes is to enter the menu corresponding to the adjusting of the color parameters. When the location information indicates that the location of the mouse cursor 220 corresponds to the control item 210D and the key information indicates that the key on the mouse 150 is triggered, the control function that the display control circuit 140 executes is to adjust the amount of the brightness of the display panel 130.

As a result, by disposing the switch circuit 120, the display apparatus 100 of the present invention can transmit the mouse input signal MIS of the mouse 150 to the computer host terminal 160, as a signal relay, under the mouse signal transmission mode. Further, the display apparatus 100 of the present invention can control the on-screen display frame 200 to further adjust the display parameter of the display panel 130 according to the mouse input signal MIS of the mouse 150 under the on-screen display control mode. The display apparatus 100 is able to transmit a mouse input signal to a computer host terminal and make use of the mouse input signal to adjust an on-screen display frame in an intuitive way at the same time.

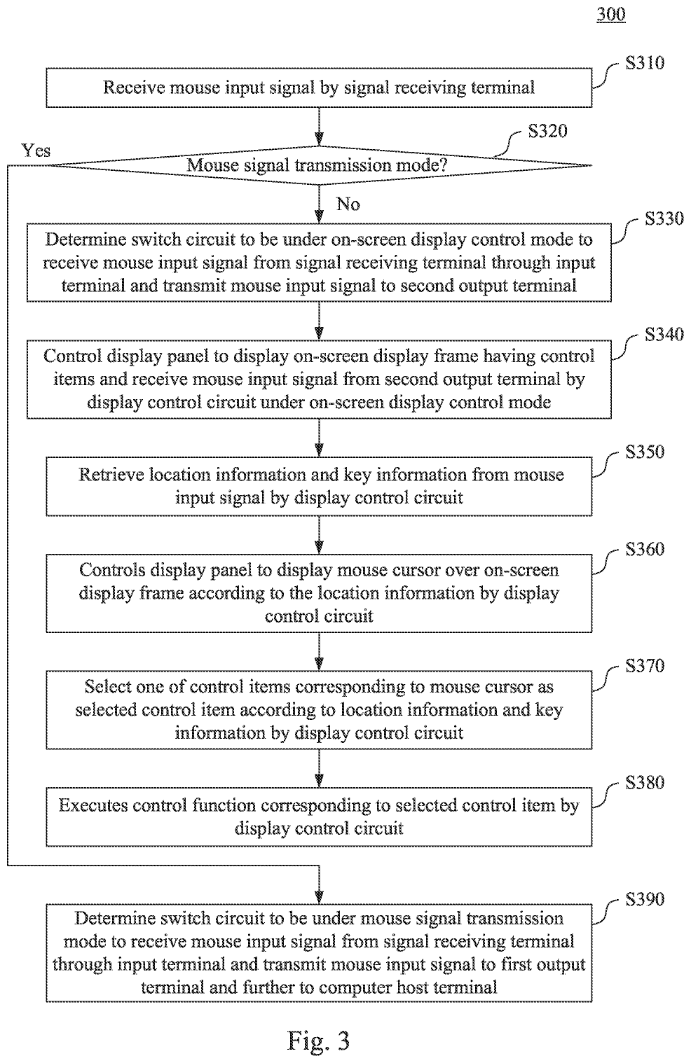

Reference is now made to FIG. 3. FIG. 3 illustrated a flow chart of an on-screen display control method 300 according to an embodiment of the present invention.

In addition to the apparatus described above, the present disclosure further provides the on-screen display control method 300 that can be used in such as, but not limited to, the display apparatus 100 in FIG. 1. As illustrated in FIG. 3, an embodiment of the on-screen display control method 300 includes the following steps.

In step S310, the mouse input signal MIS is received by the signal receiving terminal 110.

In step S320, whether the switch circuit 120 is under the mouse signal transmission mode is determined.

In step S330, when the switch circuit 120 is not under the mouse signal transmission mode, the switch circuit 120 is determined to be under the on-screen display control mode to receive the mouse input signal MIS from the signal receiving terminal 110 through the input terminal IN and transmit the mouse input signal MIS to the second output terminal O2.

In step S340, the display control circuit 140 controls the display panel 130 to display the on-screen display frame 200 having the control items (e.g. the control items 210A˜210F) and receive the mouse input signal MIS from the second output terminal O2 under the on-screen display control mode.

In step S350, the display control circuit 140 retrieves the location information and the key information from the mouse input signal MIS.

In step S360, the display control circuit 140 controls the display panel 130 to display the mouse cursor 220 over the on-screen display frame 200 according to the location information.

In step S370, the display control circuit 140 selects one of the control items corresponding to the mouse cursor 220 (e.g. the control item 210D) as the selected control item according to the location information and the key information.

In step S380, the display control circuit 140 executes the control function corresponding to the selected control item.

In step S390, when the switch circuit 120 is under the mouse signal transmission mode, the mouse input signal MIS is received from the signal receiving terminal 110 through the input terminal IN and the mouse input signal MIS is transmitted to the first output terminal O1 and further to the computer host terminal 160.

It is appreciated that the embodiments described above are merely an example. In other embodiments, it should be appreciated that many modifications and changes may be made by those of ordinary skill in the art without departing, from the spirit of the disclosure.

In summary, the display apparatus having on-screen display control mechanism and the on-screen display control method of the same of the present invention is able to transmit a mouse input signal to a computer host terminal and make use of the mouse input signal to adjust an on-screen display frame in an intuitive way by disposing the switch circuit.

The aforementioned descriptions represent merely the preferred embodiments of the present invention, without any intention to limit the scope of the present invention thereto. Various equivalent changes, alterations, or modifications based on the claims of present invention are all consequently viewed as being embraced by the scope of the present invention.

What is claimed is:

1. A display apparatus having on-screen display control mechanism, comprising:
a signal receiving terminal configured to receive a mouse input signal;
a switch circuit configured to receive the mouse input signal from the signal receiving terminal through an input terminal, and to transmit the mouse input signal to a first output terminal under a mouse signal transmission mode and transmit the mouse input signal to a second output terminal under an on-screen display control mode;
a display panel; and
a display control circuit electrically coupled to the switch circuit and the display panel and configured for:
controlling the display panel to display an on-screen display frame having a plurality of control items, and receiving the mouse input signal from the second output terminal under the on-screen display control mode;
retrieving location information and key information from the mouse input signal;
controlling the display panel to display a mouse cursor over the on-screen display frame according to the location information;
selecting one of the control items corresponding to the mouse cursor as a selected control item according to the location information and the key information; and
executing a control function corresponding to the selected control item.

2. The display apparatus of claim 1, wherein first output terminal is electrically coupled to a computer host terminal, and the switch circuit is configured to transmit the mouse input signal from the first output terminal to the computer host terminal under the mouse signal transmission mode.

3. The display apparatus of claim 1, wherein the mouse input signal comprises human interface device (HID) descriptor information, and the display control circuit is configured to retrieve the location information and the key information from the human interface device descriptor information.

4. The display apparatus of claim 1, wherein the signal receiving terminal is a universal serial bus (USB) connection interface to be electrically coupled to a mouse to receive the mouse input signal from the mouse.

5. The display apparatus of claim 1, wherein the switch circuit switches to operate between the mouse signal transmission mode and on-screen display control mode according to a switch control signal generated from a computer host terminal or generated from a physical key comprised in the display apparatus.

6. The display apparatus of claim 1, wherein the control function comprises entering or exiting a menu, or adjusting a display parameter of the display panel.

7. An on-screen display control method used in a display apparatus comprising:
receiving a mouse input signal by a signal receiving terminal;
receiving the mouse input signal from the signal receiving terminal through an input terminal by a switch circuit, transmitting the mouse input signal to a first output terminal under a mouse signal transmission mode and transmitting the mouse input signal to a second output terminal under an on-screen display control mode by the switch circuit;
controlling the display panel to display an on-screen display frame having a plurality of control items, and receiving the mouse input signal from the second output terminal under the on-screen display control mode by a display control circuit;
retrieving location information and key information from the mouse input signal by the display control circuit;
controlling the display panel to display a mouse cursor over the on-screen display frame according to the location information by the display control circuit;
selecting one of the control items corresponding to the mouse cursor as a selected control item according to the location information and the key information by the display control circuit; and
executing a control function corresponding to the selected control item by the display control circuit.

8. The on-screen display control method of claim 7, wherein first output terminal is electrically coupled to a computer host terminal, the on-screen display control method further comprises:
transmitting the mouse input signal from the first output terminal to the computer host terminal under the mouse signal transmission mode by the switch circuit.

9. The on-screen display control method of claim 7, wherein the mouse input signal comprises a human interface device (HID) descriptor information, the on-screen display control method further comprises:
retrieving the location information and the key information from the human interface device descriptor information by the display control circuit.

10. The on-screen display control method of claim 7, wherein the signal receiving terminal is a universal serial bus (USB) connection interface to be electrically coupled to a mouse to receive the mouse input signal from the mouse.

11. The on-screen display control method of claim 7, further comprising:
switching the switch circuit to operate between the mouse signal transmission mode and on-screen display control mode according to a switch control signal generated from a computer host terminal or generated from a physical key comprised in the display apparatus.

12. The on-screen display control method of claim 7, wherein the control function comprises entering or exiting a menu, or adjusting a display parameter of the display panel.
